(19) United States
(12) Patent Application Publication
(10) Pub. No.: US 2020/0382685 A1
(43) Pub. Date: Dec. 3, 2020

(54) REAL TIME IMAGING AND WIRELESS TRANSMISSION SYSTEM AND METHOD FOR MATERIAL HANDLING EQUIPMENT

(71) Applicant: Aspire Pharmaceutical Inc., Somerset, NJ (US)

(72) Inventors: Madhav Tonse PAI, Jersey City, NJ (US); Zino ALTMAN, Newtown, PA (US)

(21) Appl. No.: 16/997,918

(22) Filed: Aug. 19, 2020

Related U.S. Application Data
(63) Continuation of application No. 15/268,622, filed on Sep. 18, 2016, now abandoned.
(60) Provisional application No. 62/220,453, filed on Sep. 18, 2015.

(51) Int. Cl. H04N 5/225; G06Q 10/08; G06T 7/00

(52) U.S. Cl. CPC H04N 5/2256; G06T 7/001; G06Q 10/087

(57) ABSTRACT

Exemplary embodiments of present invention are directed to inspection, processing, and quality control of capsules, tablets, and/or caplets containing variety of food supplements and/or medications. System is provided comprising: product carrier configured to transport at least one product; vision system configured to obtain and output inspection data of at least one product; non-transitory computer readable medium storing reference data sufficient to define at least one quality criteria for at least one product; and dedicated computer system in communication with vision system. The computer system includes a microprocessor executing computer-readable instructions applying logic rules to reference data and inspection data to selectively identify and assign unique set of coordinates in local or global coordinate system to at least one product.

### CROSS-REFERENCE TO RELATED APPLICATIONS

This application is a continuation of U.S. Non-Provisional patent application Ser. No. 15/268,622, filed Sep. 18, 2016, which claims priority to prior U.S. Provisional Patent Application No. 62/220,453, filed Sep. 18, 2015, the entire contents of which are incorporated herein by reference.

### BACKGROUND OF THE INVENTION

Generally, exemplary embodiments of the present invention relate to the fields of inspection and processing of mass produced relatively small items sold/delivered to consumer in high quantities. In particular, exemplary embodiments of the present invention are directed to inspection, processing, and quality control of capsules, tablets, and/or caplets containing a variety of food supplements and/or medications.

Conventionally, food supplements and mediations are produced in high quantities for delivery to consumers, for example in the form of soft gelatin capsules, tablets, caplets and/or two-piece capsules containing a variety of food supplements, vitamins, minerals, over the counter drugs (OTC's), prescription (Rx) medications, and other controlled and/or regulated substances. Widely accepted methods of inspection and processing of such high value products in large scale production involve: human visual inspection of individual items to determine whether they meet certain acceptance requirements or have specific undesirable qualities; manual separation of the defective items from the acceptable ones; and consolidation of the acceptable items into production or shippable batches. While there are various techniques for visual inspection, as well as separation and consolidation of capsules, tablets, and caplets, there are no tools available specifically for automation of inspection and quality control for such high-quantity products. Accordingly, conventional methods and techniques for such operations have at least the drawbacks of inefficiency, inconsistency and cost associated with manual processes.

### SUMMARY OF EXEMPLARY EMBODIMENTS OF THE INVENTION

The matters exemplified in this description are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An exemplary embodiment of the present invention provide a system comprising a product carrier configured to transport at least one product a vision system configured to obtain and output inspection data of at said least one product a non-transitory computer readable medium storing reference data sufficient to define at least one quality criteria for said at least one product; and a dedicated computer system in communication with said vision system, said computer system including a microprocessor executing computer-readable instructions applying logic rules to said reference data and said inspection data to selectively identify and assign a unique set of coordinates in a local or global coordinate system to said at least one product.

Another exemplary embodiment of the present invention provides a method of handling rejected products deploying a system including product carrier and a vision system, the method comprising; placing a plurality of products on said product carrier; inspecting said products by said deployed system including illumination and mapping; evaluating results of the inspecting; and communicating the results of the evaluating to said sorting and/or removal system for sorting and/or removal of said rejected and non-rejected products.

Yet another exemplary embodiment of the present invention provides a system where the computer-readable instructions applying logic rules and/or the reference data are stored in whole or in part on said non-transitory computer readable medium.

According to exemplary implementations of exemplary embodiment of the present invention the computer system comprises at least one of an internal non-transitory computer readable storage medium and at least one interface to at least one of an external portable non-transitory computer readable storage medium, the computer-readable instructions applying logic rules and/or the reference data are stored in whole or in part on at least one of the internal non-transitory computer readable storage medium and the external portable non-transitory computer readable storage medium.

According to another exemplary implementation of exemplary embodiment of the present invention, the vision system comprises: a dedicated microprocessor; a dedicated non-transitory computer readable medium; at least one integrated and/or remote illumination and/or sensing device configured with respect to the at least one product.

According to yet another exemplary implementation of exemplary embodiment of the present invention the dedicated microprocessor controls said at least one integrated and/or remote illumination and/or sensing device based on said computer-executable instructions.

According to yet another exemplary implementation of exemplary embodiment of the present invention, the at least one of the microprocessor and the dedicated microprocessor executes the computer-readable instructions automatically and/or based on instructions for the computer system.

According to yet another exemplary implementation of exemplary embodiment of the present invention, the vision system controls, and receives input from, the at least one integrated and/or remote illumination and/or sensing device, and the vision system collects and/or process inspection data in real time and/or collect and stores inspection data on one or more of the non-transitory computer readable medium.

According to yet another exemplary implementation of exemplary embodiment of the present invention, the vision system references the inspection data for at least one of future processing and/or historic evaluation and/or calibration.

According to yet another exemplary implementation of exemplary embodiment of the present invention, the vision system comprises a plurality of the light source arranged in various geometrical patterns to facilitate minimization, or virtual elimination, of shadows cast by the products, such as shadows cast by said at least one product on said product carrier.

According to yet another exemplary implementation of exemplary embodiment of the present invention, a plurality of the light source are configured to have and/or be selectively assigned by the microprocessor, illumination wavelength spectrum selected in reference to optical density of at least one product to create greater contrast to a background provided by the product carrier.

According to yet another exemplary implementation of exemplary embodiment of the present invention, the system further comprises a sorting and/or removal system including a second dedicated microprocessor, a second non-transitory computer readable medium, and at least one integrated and/or remote product manipulation device.

According to yet another exemplary implementation of exemplary embodiment of the present invention, manipulation device includes a multi-axis robot, or any other motion device, configured to selectively remove said at least one product from said product carrier.

According to yet another exemplary implementation of exemplary embodiment of the present invention, sorting and/or removal system selectively removes identified rejected products from a plurality of products located on the product carrier and releases non-rejected products into a shippable batch.

According to yet another exemplary implementation of exemplary embodiment of the present invention, coordinates or series of coordinates of said identified rejected products on the product carrier are determined by the vision system and communicated to the sorting and/or removal system to control the at least one integrated and/or remote product manipulation device to correctly remove the rejected products and releases the non-rejected products.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIGS. 1, 2, and 3, illustrate examples of such products, which can be randomly or orderly distributed on a product carrier of a system according to exemplary embodiments of the present invention.

FIG. 4 is a generalized block diagram of a system and according to exemplary embodiments of the present invention.

FIG. 5 is a generalized logic flow block diagram of a methodology according to exemplary embodiments of the present invention.

### DETAILED DESCRIPTION OF EXEMPLARY EMBODIMENTS OF THE INVENTION

Exemplary embodiments of the present invention address at least these issues by providing a systems and methods including product sorting techniques based on the products' specific quality requirements, where novel processes and combinations of tools are deployed to recognize product qualities, thereby automating inspection and quality control to reduce or eliminating conventionally required manual processing.

Referring now to the drawings, wherein like reference numerals designate identical or corresponding parts throughout the several views, embodiments of the present invention are shown in schematic detail. A skilled artisan will readily appreciate that any references to specific software, tools and/or components by their manufacturer or brand name are merely for exemplary purposes and not to limit the scope of the invention.

The matters defined in the description such as a detailed construction and elements are nothing but the ones provided to assist in a comprehensive understanding of the invention. Accordingly, those of ordinary skill in the art will recognize that various changes and modifications of the embodiments described herein can be made without departing from the scope and spirit of the invention. Also, well-known functions or constructions are omitted for clarity and conciseness. Certain exemplary embodiments of the present invention are described below in the context of commercial application. Such exemplary implementations are not intended to limit the scope of the present invention, which is defined in the appended claims.

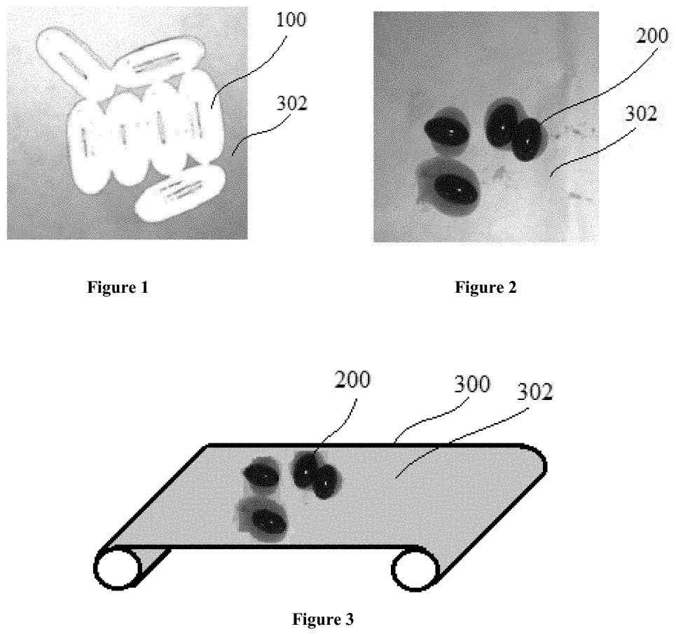

According to an exemplary implementation of the present invention, unique illumination techniques and high resolution vision system(s) are configured for product inspection, where each rejected product is identified and assigned its own set of coordinates in the local or global coordinate system. FIGS. 1, 2 and 3, illustrate examples of such products, 100 and 200, which can be randomly or orderly distributed on product carrier(s) 300 or otherwise.

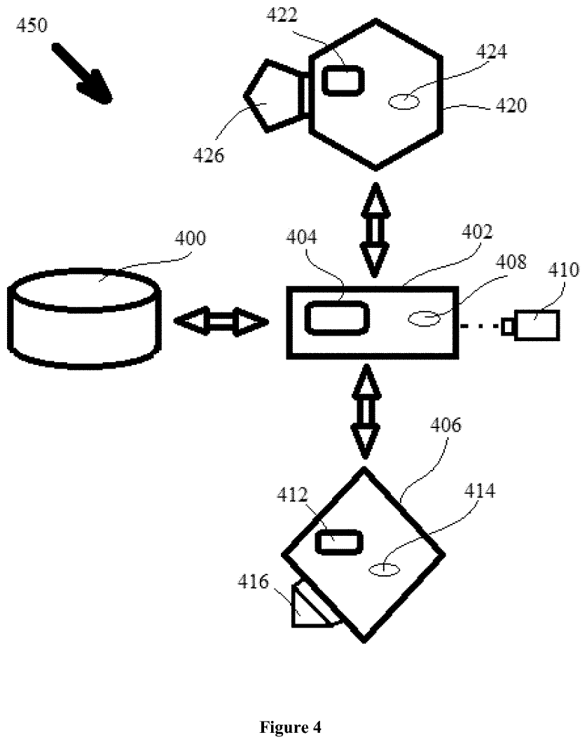

Referring to an illustrative block diagram of FIG. 4, according to an exemplary embodiment of the present invention, system 450 is provided where identification of the rejected product is based on products' specific quality requirement, such that, according to a further exemplary embodiment of the present invention, reference data sufficient to define products' quality requirements can be stored on non-transitory computer readable medium 400. Associated computer-implemented processing can be provided by a specifically configured computer system 402 in communication with vision system 406 configured to obtain and output inspection data of, for example, products 200 disposed on product carrier 300. Computer system 402 includes a microprocessor 404 executing computer-readable instructions applying logic rules to the reference data and inspection data to identify and assign its own set of coordinates in the local or global coordinate system to rejected product(s). In an exemplary implementation, the computer-readable instructions applying logic rules and/or the reference data can be stored in whole or in part on medium 400, or internal storage medium 408 of computer system 402, or any other internal or portable medium (such as a USB-type drive) 410 capable of data exchange with, for example, computer system 402.

According to exemplary embodiments of the present invention, vision system 406 includes a microprocessor 412 and non-transitory computer readable medium 414, as well as integrated and/or remote illumination and/or sensing device(s) 416 configured with respect to, for example, carrier 300. In an exemplary implementation, microprocessor 412 can control device(s) 416 based on computer-executable instructions stored on one or more of medium 414 and/or medium 400 and/or medium 410, which can be executed automatically and/or based on instructions from, for example, computer system 402. In a further exemplary implementation, vision system 406 controlling and using input from device(s) 416 can collect and/or process inspection data in real time and/or collect and store inspection data on one or more of medium 414 and/or medium 400 and/or medium 410 for future processing and/or historic evaluation and/or calibration.

In an exemplary implementation of a vision system 406 according to embodiments of the present invention, illumination can be performed by illumination and/or sensing device(s) 416 comprising a plurality of the light source arranged in various geometrical patterns to facilitate minimization, or virtual elimination, of shadows cast by the products, such as shadows cast by products 200 on product carrier 300. In a further exemplary implementation, device(s) 416 can be configured to have and/or selectively assigned by for example microprocessor 412, illumination wavelength spectrum selected in reference to the products optical density in order to create greater contrast to the background. For example, for organic products near UV spectrum can be used to facilitate appearance of such products toward becoming color independent and highly contrasted. While the vision system according to exemplary embodiments of the present invention is not necessarily limited to any particular wavelength, optics and image acquisition devices can be matching to the illumination spectrum for the image quality improvement.

In yet further exemplary implementations of the embodiments of the present invention, once image is acquired and processed, vision system 406 can create a matrix of the products, which did not meet any selected and/or preset criteria (for example, size, color, shape, etc.), and deviation from the criteria can be interpreted as an indication of presence of other substance(s) and/or damaged product. In still further exemplary implementation of the present invention, an imaging plane can be correlated to a multidimensional coordinate system, where defective products are identified and associated with their location in the imaging plane, for example, so that a pick up mechanism can reference the same coordinate system to locate and discard defective products. An exemplary implementation of such a pick up mechanism is described in more detail below.

Another exemplary embodiment of the present invention further provides a sorting and/or removal system 420 including a microprocessor 422 and a non-transitory computer readable medium 424, as well as an integrated and/or remote product manipulation device(s) 426. In an exemplary implementation, manipulation device(s) 426 can include a multi-axis robot, or any other motion device, which can remove a product, in particular an identified rejected product, from the product population, located for example on carrier 300, and releases the good (not rejected) products into a shippable batch. While products can be randomly or orderly distributed on the product carriers, such as carrier 300, or otherwise, the coordinates or series of coordinates determined by system 402 are communicated to system 420 to control device(s) 426 to correctly remove the rejected product(s) from the product population and releases the non-rejected products into the shippable batch.

According to yet further exemplary embodiments of the present invention, overall system 450 and/or individual systems (or sub-systems) 402, 406 and/or 420, can be taught or trained to identify specific product qualities as a basis for sorting and/or removing, whereby reference data can be collected and improved based on, for example, calibration, historical information, etc. Such product qualities may include, but not limited to, product size, shape, density, optical density, color, weight, surface quality and/or color, quantity, etc. For example, batches of different products can be sorted in separate batches based on size (all exceeding a reference value), optical density (all organics versus non-organics), color (all red versus other colors, or every color, etc.).

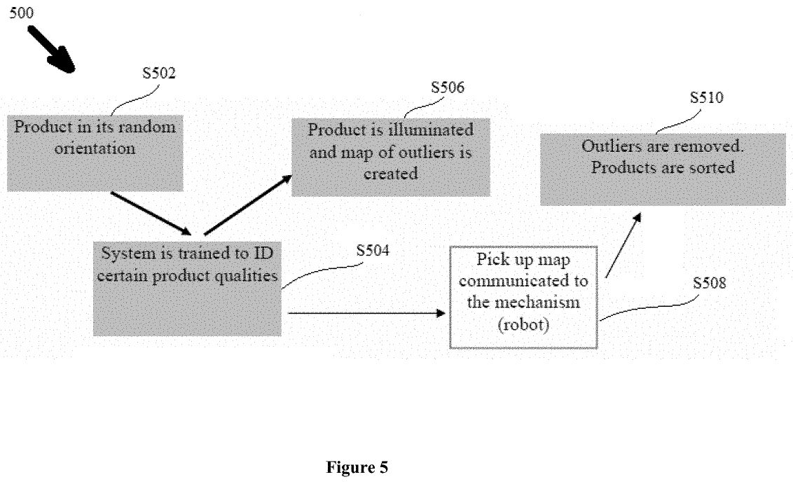

According to an exemplary implementation of the embodiments of the present invention, once system 450 is trained and/or calibrated to recognized selected qualities of products, products can be sorted using a process 500 according to exemplary embodiments of the present invention, as generally illustrated in the example of FIG. 5. For example, products initially disposed on a carrier 300, step S502, are inspected by a trained system 450, step S504, including illumination and mapping using system 406, step S506. The results of the inspection are evaluated and communicated, step S508, to sorting and/or removal system 420 for sorting and/or removal accordingly, step S510.

According to yet another exemplary implementation, using systems and methodologies according to the present invention two or more batches of a products can be created based on the requirements of a trained and/or calibrated system 450. For example, a single batch containing different products can be sorted in separate batches based on selected criteria including without limitation size (for example, all products exceeding a certain preset or selected value), optical density (for example, all organics versus non-organics), and/or color (for example, red versus other colors, or every color), where a product or products not meeting the criteria of can removed and an acceptable product (i.e., product meeting the criteria) can be transferred to containers for further processing,

In yet further exemplary implementation, according to an exemplary methodology as new products are introduced to a system, they can be placed spaced apart on the same background as future processing may require so that their images can be acquired in advance. Then, for example, system can create combined product image and/or product evaluation criteria, which can be used to identify acceptable products versus defective ones. In addition, a system can be configured with a capability of expanding acceptance and/or rejection criteria related to one and/or several specific product quality attribute(s) to accommodate and/or eliminate possible size, shape or other variations.

According to yet other exemplary implementations, using systems and methodologies according to the present invention can facilitate recovery and/or sorting of batches of valuable products, which, for example were degraded due to the mix up or packaging damages. For example, and without limitation, systems and methodologies according to the present invention can facilitate recovery and/or sorting of:
Gold plated contacts mixed with non-gold plated lesser quality parts. Sorting based on color.
Soft gelatin, Tablets, caplets, two piece capsules, containing vitamins, minerals, over the counter drugs (OTC's) prescription (Rx) products mixed with the tablets of other purpose. Sorting is based on optical density.
Broken container of the gelatin capsule (gel cap) of any sort. Pieces of container can be identified and removed. Sorting based on material: organics versus non-organics.
Plastic molded buttons mixed in one batch, where multiple colors are present and color coordinated sorting required. Sorting based on color.
Bolts and nuts accidentally mixed together. Sorting is based on the shape/size.
Golf balls and ping pong balls mixed together. Sorting is based on density only.

According to yet other exemplary implementations, systems and methodologies according to the present invention system 450 can be configured with a specific illumination including, for example, vision system 406 having an illumination device 416 configure to output near UV illumination in 300-420 nm spectrum to cause clear appearance of difference between leaking and defective products and good products where a product includes gel caps.

According to yet another exemplary implementations, vision system 406 can be configured such that sensing device 416 includes multiple high speed and high resolution cameras with optics optimized for a desired illumination (for example, near UV illumination in 300-420 nm spectrum) to facilitate high degree of fidelity in identification of product defect(s).

According to yet other exemplary implementations, sorting and/or removal system 420 can be configured to include a six axis robot or any other motion device to remove the defective products and process the good products.

While the present invention has been shown and described with reference to certain exemplary embodiments thereof, it will be understood by those skilled in the art that various changes in form and details may be made therein without departing from the spirit and scope of the present invention. For example, exemplary embodiments of the present invention apply without limitation to:
products that are optically transparent;
products that are colored in any color and vary in size;
products that are produced from any organic material;
use of vision systems including single camera or photosensitive device;
use of vision systems including plurality of the photosensitive devices;
use of sorting and/or removal systems configure to manipulate any style, size, payload or configured with plurality of robots; and
Carrier and/or sorting and/or removal systems where any style of product handling mechanism is used.

The present embodiments are, therefore, to be considered in all respects as illustrative and not restrictive. Additionally, it will be appreciated that any features, components, elements, etc., described above in relation to different exemplary embodiments may be implemented together.

In addition, the drawing figures that follow further describe non-limiting examples of implementations of certain exemplary embodiments of the present invention and aid in the description of technology associated therewith. Any specific or relative dimensions or measurements provided in the drawings are exemplary and not intended to limit the scope or content of the inventive design or methodology as understood by artisans skilled in the relevant field of invention.

Furthermore, the above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well known and available to those having skill in the computer software arts. Examples of non-transitory computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and so on, including a carrier wave transmitting signals specifying the program instructions, data structures, and so on. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Other objects, advantages and salient features of the invention will become apparent to those skilled in the art from the details provided, which, taken in conjunction with the annexed drawing figures, disclose exemplary embodiments of the invention.

We claim:

1. A system comprising:
a product carrier configured to transport at least one product disposed at a location on a surface of said carrier;
a vision system configured to obtain and output inspection data comprising at least one physical characteristic of said at least one product and said location of said at least one product on said surface of said carrier;
a non-transitory computer readable medium storing reference data defining at least one quality criteria for said at least one product; and
a dedicated computer system in communication with said vision system, said dedicated computer system including a microprocessor executing computer-readable instructions applying logic rules to said reference data and said inspection data to selectively identify said at least one product at said location on said surface of said carrier, and assign to said identified at least one product a unique fixed set of coordinates for said location of said identified at least one product on said surface of said carrier in a local or global coordinate system, based on said application of said logic rules.

2. The system of claim 1, wherein at least one of the computer-readable instructions applying logic rules and the reference data are stored at least in part on said non-transitory computer readable medium.

3. The system of claim 1, wherein
said computer system comprises at least one of an internal non-transitory computer readable storage medium and at least one interface to at least one of an external portable non-transitory computer readable storage medium, and
at least one of said computer-readable instructions applying said logic rules and said reference data is stored at least in part on at least one of said internal non-transitory computer readable storage medium and said external portable non-transitory computer readable storage medium.

4. The system of claim 3, wherein said vision system comprises:
a dedicated microprocessor;
a dedicated non-transitory computer readable medium;
at least one of an illumination device and a sensing device configured with respect to said product carrier and said at least one product.

5. The system of claim 4, wherein said dedicated microprocessor controls said at least one of said illumination device and said sensing device based on said computer-executable instructions.

6. The system of claim 5, wherein at least one of said microprocessor and said dedicated microprocessor executes said computer-readable instructions automatically, based on instructions for said computer system, or automatically and based on instructions for said computer system.

7. The system of claim 4, wherein said vision system controls, and receives input from, said at least one of said illumination device and said sensing device, and
said vision system at least one of:
collects said inspection data,
processes said inspection data in real time, and
stores inspection data on one or more of said non-transitory computer readable medium.

8. The system of claim 7, wherein said vision system references said inspection data for at least one of future processing, historic evaluation, and calibration.

9. The system of claim 1, wherein said vision system comprises a plurality of light sources arranged in geometrical patterns to minimize shadows cast by said at least one product.

10. The system of claim 9, wherein at least one of said light sources is configured to output an illumination wavelength spectrum selected in reference to an optical density of said at least one product to contrast said at least one product illuminated by said at least one light source to a background provided by said product carrier.

11. The system of claim 1, further comprising:
a sorting and removal system including a second dedicated microprocessor, a second non-transitory computer readable medium, and at least one product manipulation device.

12. The system of claim 11, wherein said manipulation device includes a multi-axis motion device to at least one of
selectively separate said at least one product from other products on said product carrier, and
selectively remove said at least one product from said product carrier.

13. The system of claim 12, wherein said sorting and removal system is configure to
selectively identify said at least one product as a rejected product based on said application of said logic rules,
remove said rejected product from a plurality of non-rejected products located on said product carrier, and
release said non-rejected products into a shippable batch.

14. The system of claim 13, wherein at least one of coordinates and series of coordinates of said rejected product on said product carrier are determined by said vision system and communicated to said sorting and removal system to control said at least one product manipulation device to remove the rejected product and release the non-rejected products.

15. A method of handling rejected products comprises:
deploying a system comprising
a product carrier configured to transport at least one product disposed at a location on a surface of said carrier;
a vision system configured to obtain and output inspection data comprising at least one physical characteristic of said at least one product and said location of said at least one product on said surface of said product carrier;
a non-transitory computer readable medium storing reference data defining at least one quality criteria for said at least one product; and
a dedicated computer system in communication with said vision system, said dedicated computer system including a microprocessor executing computer-readable instructions applying logic rules to said reference data and said inspection data to selectively identify said at least one product at said location on said surface of said carrier and assign to said identified at least one product a unique fixed set of coordinates for said location of said identified at least one product on said surface of said product carrier in a local or global coordinate system based on said application of said logic rules;
placing a plurality of products on said product carrier at a plurality of locations on said surface of said carrier associated with each of said products; and
inspecting said products by said deployed system including obtaining and outputting said inspection data comprising at least one physical characteristic of said at least one product and said location of said at least one product on said surface of said product carrier; and
evaluating results of the inspecting including applying said logic rules to said reference data and said inspection data to selectively identify at least one product of said plurality of products at said location on said surface of said carrier, and assign to said identified at least one product said unique fixed set of coordinates for said location of said plurality of locations on said surface of said carrier associate with said identified at least one product in said local or global coordinate system, based on said application of said logic rules.

16. The method of claim 15, wherein
said vision system comprises a plurality of light sources arranged in geometrical patterns, and
said inspecting of said products further comprises illuminating said products by said light sources to minimize shadows cast by said products.

17. The method of claim 16, wherein said illuminating comprises outputting an illumination wavelength spectrum selected in reference to an optical density of said products to contrast said products illuminated by said light sources to a background provided by said product carrier.

18. The method of claim 15, wherein said deployed system further comprises a sorting and removal system including a second dedicated microprocessor, a second non-transitory computer readable medium, and at least one product manipulation device, said method further comprising:
communicating the results of the evaluating to said sorting and removal system; and
manipulating said products to at least one of
selectively separate said at least one product from other products on said product carrier, and
selectively remove said at least one product from said product carrier.

19. The method of claim 18, wherein the manipulating comprises:
selectively identifying said at least one product as a rejected product based on said application of said logic rules;
removing said rejected product from said products located on said product carrier, and
releasing said non-rejected products into a shippable batch.

20. The method of claim 19, wherein said unique set of coordinates are associated with said rejected product, the communicating comprises transmitting said unique set of coordinates to said sorting and removal system to control said at least one product manipulation device to remove the rejected product.
